(19) United States
(12) Patent Application Publication
(10) Pub. No.: US 2020/0282481 A1
(43) Pub. Date: Sep. 10, 2020

(54) HYDRAULICALLY ACTIVATED CUTTING TOOL

(71) Applicant: GUSTAV KLAUKE GMBH, Remscheid (DE)

(72) Inventors: Andreas Lehr, Neuss (DE); Egbert Frenken, Heinsberg (DE)

(21) Appl. No.: 16/807,328

(22) Filed: Mar. 3, 2020

(30) Foreign Application Priority Data
Mar. 5, 2019 (DE) 10 2019 105 500.8

(51) Int. Cl. B23D 35/00; B23D 17/06; B23D 29/00; B26B 15/00

(52) U.S. Cl. CPC B23D 35/001; B26B 15/00; B23D 29/00; B23D 17/06

(57) ABSTRACT

A hydraulically activated cutting tool with first and second pivoting jaws that can pivot around a shared pivot axis is provided. A blade is formed on the first pivoting jaw and a stop is formed on the second pivoting jaw. The blade has a cutting edge that runs in the direction of the pivot axis. A gripping section is formed on the second pivoting jaw and protrudes over a stop surface of the stop in the direction toward the first pivoting jaw. A method for separating an H-tap crimped connection of two cables with a cutting tool is also provided.

### AREA OF TECHNOLOGY

The invention relates to a hydraulically activated cutting tool with two pivoting jaws that can pivot around a shared pivot axis, wherein a blade is formed on one pivoting jaw, and a stop on the other pivoting jaw.

The invention further relates to a method for separating a crimped connection, which connects two strand-shaped parts with each other, in particular two cables, preferably in the form of an H-tap crimped connection, with a cutting tool.

### PRIOR ART

For example, a cutting tool of the kind in question is known from DE 20 2006 009 273 U1 (U.S. Pat. No. 8,671,579 B2). The pivoting jaws can be pivoted toward each other via the piston of a hydraulically activatable working tool, wherein the blade of the one pivoting jaw is moved in the direction toward the stop of the other pivoting jaw during this pivoting motion. An object arranged between the blade and stop, for example a rod-shaped object, further such as a cable or a bar, is cut by the blade as it abuts against the stop during this pivoting displacement.

### SUMMARY OF THE INVENTION

With respect to the prior art described above, one object of the invention is regarded as improving a cutting tool of the kind in question in an advantageous manner and indicating an advantageous method for separating a crimped connection, in particular an H-tap crimped connection.

In a first inventive idea, one possible solution to the object involves a cutting tool in which the aim is for the blade to have a cutting edge that runs in the direction of the pivot axis, and to provide a gripping section that is formed on the pivoting jaw which has the stop and protrudes over a stop surface of the stop in the direction toward the opposing pivoting jaw. In a possible alternative embodiment, the gripping section can also be provided on the pivoting jaw which has the blade.

With respect to the method, it can be provided that the gripping section be designed to overlap sections of the strand-shaped parts that extend in the longitudinal direction of the strand-shaped parts before and/or after the connection, and that, given a gripping section that abuts against the strand-shaped part, the blade cuts through the crimped connection in such a way that the strand-shaped part can be removed.

In the following, reference to the crimped connection always also includes the H-tap crimped connection, but the embodiments also apply to a more general form of a given crimped connection in this regard. In addition, the focus is always placed on one or two cables with respect to the strand-shaped parts. However, the statements similarly apply more generally with reference to one or two strand-shaped parts.

The cutting tool is advantageously improved as a result of the indicated configuration. The cutting tool is now (also) suitable for cutting open crimped connections, for example, and further so-called H-tap crimped connections, for example, so as to again expose in particular one of the cables connected with each other by such a crimped connection, or remove the electrical connection to the other cable.

For this purpose, the cutting edge of the blade is aligned in a suitable manner in the direction of the pivot axis of the pivoting jaw. Accordingly, this makes it possible to align the cutting edge in essentially the direction of extension of a cable connected by the crimped connection.

The preferably provided gripping section makes it possible to overlap a cable, in particular the cable to be initially released from the crimped connection, preferably outside of the crimped connection, in particular to the side of the crimped connection. This overlap makes it possible to achieve a precise positioning of the crimped connection on the cutting tool, in particular on its stop. As is also preferred, this precise positioning can lead to a defined cutting process using the pivoting jaw blade; during this cutting process, the blade enters into the crimped connection transversely to the pivot axis along a circular line in relation to a plane, and separates or breaks it further along this circular line.

The user can hold the cutting tool close with a slight tug upon initiating the cutting process, so as to thereby ensure the desired cutting result. As also preferred in practice, this also makes it possible to expose the cable to be released and/or the H-tap crimped connection to a load, in particular a tensile load, using the gripping section, so as to thereby assume the desired cutting position in which the crimped connection is to be held in the cutting tool during the cutting process.

The blade can here further approximately and further preferably at least partially make tangential contact with the respective cable, or be passed by this cable tangentially at a small distance of up to 1 mm, for example, if necessary of up to 5 mm, for example.

Additional features of the invention are often explained below, to include the description to the figures, in their preferred allocation to the subject matter of claim 1 or to features of other claims. However, they can also be important as allocated to only individual features of claim 1 or the respective other claim, or each independently.

In a further development, the gripping section can form a front peripheral edge in the pivoting direction, which, as viewed in the direction of the pivot axis, is arranged to the side of the cutting edge. In this way, the gripping section can slide laterally by the blade during the cutting motion or the pivoting motion of the blade in the direction toward the stop.

In another possible configuration, the stop, in particular its stop surface, as well as the cutting edge can have identical or at least approximately identical extended lengths as viewed in the direction of the pivot axis. Given a gripping section arranged directly to the side of the stop, the cutting edge and gripping section can pivot by each other in almost a directly lateral manner during the cutting and pivoting displacement. In this way, the gripping section can form a lateral guide stop for the H-tap.

In addition, this effect can also come about by having two gripping sections each be arranged at one end of the stop surface as viewed in the direction of the pivot axis, as further preferred. In such an arrangement, the H-tap is preferably flanked by the gripping sections on both sides relative to the longitudinal extension of the cable, and drawn into the stop position via the cable overlapped by the gripping sections given a corresponding tensile load.

This can also cause the blade to cut uniformly into the material of the H-tap over the length of its cutting edge and separate it.

One or both gripping sections can be pivotably arranged, for example such that only one gripping section in an overlap position gets to the cable crimped in the H-tap. By contrast, the other gripping section can be pivoted into a position in which it is unsuitable for overlapping the cable. For example, such a pivoting displacement of a gripping section into a non-overlapping position can make sense in crimping connections or H-taps that have a larger degree of extension viewed in the direction of the pivot axis than would be permitted by the clear distance between two gripping sections or the length of the stop surface in the direction of the pivot axis.

Local conditions that do not permit any overlap might also cause one or even both gripping sections to be pivoted into a non-overlapping position.

It is possible to fixedly latch one or both gripping sections into at least one pivoting position, preferably at least into the position that does allow an overlap. The selected latched position must here be stable enough that it cannot be released by forces (in particular tensile forces) that act on the gripping section(s) during a conventional cutting process. The respective latched position can thus only be released intentionally.

### BRIEF DESCRIPTION OF THE DRAWINGS

The invention will be described in more detail below based on the attached drawing, which only shows an exemplary embodiment. Shown on:

FIG. 1 is a perspective view of a hydraulically activated cutting tool;

FIG. 2 is a side view thereof;

FIG. 3 is a top view of the cutting tool;

FIG. 4 is the front view according to arrow IV on FIG. 3;

FIG. 5 is the section along line V-V on FIG. 4, relating to an open position of the cutting jaws with the H-tap captured in the cutting mouth by the cutting tool;

FIG. 6 is the perspective view thereof;

FIG. 7 is the view according to arrow VII on FIG. 6;

FIG. 8 is a view corresponding to FIG. 5 relating to the closed position of the cutting jaws;

FIG. 9 is the perspective view thereof;

FIG. 10 is a schematic view of the cutting line through an H-tap;

FIG. 11 is a perspective view according to FIG. 6, but relating to a situation with a disengaged gripping section;

FIG. 12 is an exploded perspective view of the pivoting jaws with two gripping sections.

### DESCRIPTION OF THE EMBODIMENTS

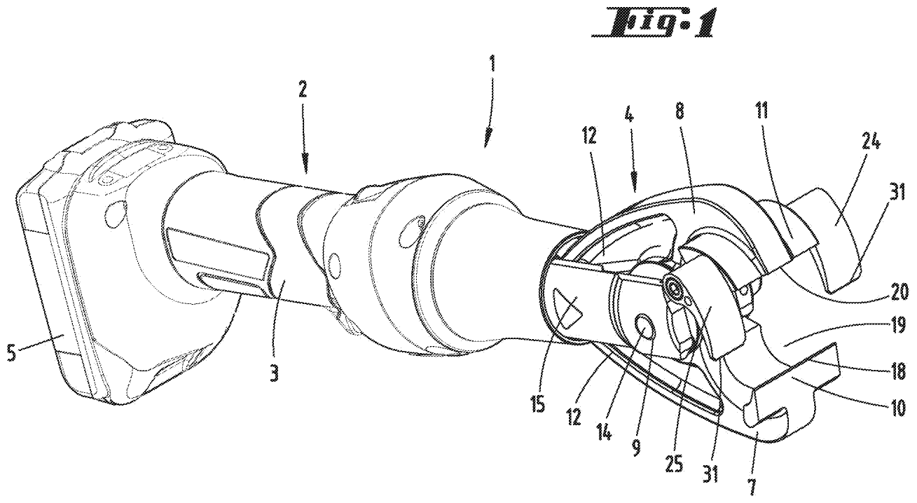

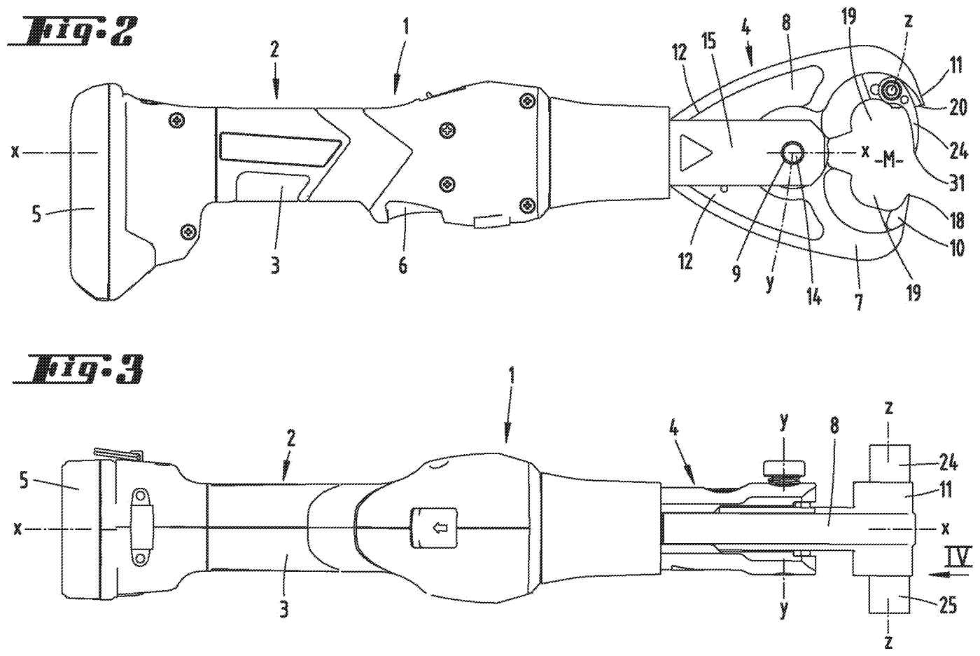

Initially shown and described in relation to the illustration on FIG. 1 is a hydraulically activatable, in particular electro-hydraulically activatable, cutting tool 1 in a rod-like configuration.

The cutting tool 1 initially and essentially has a drive unit part 2, which can simultaneously comprise a gripping area 3. Such a drive unit part 2 is known from WO 2003/084 719 A2 (U.S. Pat. No. 7,254,982 B2), for example. The content of this WO publication or US publication is hereby included in the disclosure of the present invention in its entirety, including for the purpose of also incorporating features of this WO publication or US publication into the claims of the present invention.

A working head 4 adjoins the drive unit part 2 toward a free end of the working device. It can be replaceably mounted on the drive unit part 2, preferably by a separation in the area of a hydraulic cylinder. As also preferred, the working head 4 can further be mounted in a freely rotatable manner around a working head longitudinal axis x relative to the drive unit part 2 or the respective receptacle for the working head 4.

An accumulator 5 is set up to supply electrical power in particular to an electric motor that drives the hydraulic fluid pump, but additionally to a control unit (not shown) and other electrical components in the cutting tool 1.

The gripping area 3 can be designed for conventionally grasping the cutting tool 1 with a hand. An ergonomically beneficial activating key 6 allocated to the gripping area 3 is provided.

Two pivoting jaws 7 and 8 that can be pivoted toward and away from each other are provided in the working head 4. The latter can be pivoted around a shared geometric pivot axis y, wherein this pivot axis y is transvers to the working head longitudinal axis x.

The two pivoting jaws 7 and 8 comprise a blade 10 or a stop 11 on one side of a bearing eye 9, and a respective acting surface 13 in the form of a curved path on a jaw leg 12 on the other side of the bearing eye 9.

The acting surfaces 13 of both pivoting jaws 7 and 8 are arranged facing each other.

The bearing eyes 9 of both pivoting jaws 7 and 8 are aligned coaxially to each other, and in the assembled state are penetrated by a bolt 14, for example a locking bolt. This bolt 14 is mounted in location holes of a drive head-side receiving neck 15 on either side of the pivoting jaws 7 and 8.

The receiving neck 15 has a conventional fork-shaped design, and has a bolt receptacle that extends transverse to the longitudinal extension of the receiving neck 15 and penetrates the fork leg, preferably in the form of a through bore in which the bolt 14 is mounted.

The acting surfaces 13 of the pivoting jaws 7 and 8 protrude into the area between the fork legs of the receiving neck 15, and are exposed to rollers 16 of the drive unit part that can be preferably hydraulically displaced in the direction toward the acting surfaces 13 during a pressing process, which causes the pivoting jaws 7 and 8 to spread in the area of the curved path or acting surfaces 13, and thus the blade 10 and stop 11 of the pivoting jaws 7 and 8 to be pivotably displaced in a direction toward each other.

A hydraulic piston can be provided in the working head 4 so as to pivotably displace the pivoting jaws 7 and 8 in a cutting direction. The latter can be displaced along the axis x in a hydraulic cylinder against the force of a restoring spring. The continuous surface of each roller 16 forms an interacting surface, via which the piston can indirectly act on the acting surfaces 13.

When the activating key 6 is correspondingly activated during operation of the cutting tool 1, for example by way of a pumping plunger, hydraulic fluid is pumped into the hydraulic cylinder via a hydraulic line, so as to correspondingly act on the front piston surface facing the hydraulic fluid.

The hydraulic piston displaced opposite the force of the restoring spring through exposure to a hydraulic fluid can move a carrier for the roller 16 being exposed to a piston rod 17 linearly along the longitudinal axis x, wherein the pivoting jaws 7 and 8 are displaced toward each other in the direction of a closed position as the displacement path of the rollers 16 increases proceeding from a base position according to FIG. 5 as the result of a force-transmitting interaction between rollers 16 and the curved path-like acting surfaces 13.

The blade 10 of the one pivoting jaw 7 has a cutting edge 18. The latter runs in the direction of the pivot axis y, correspondingly preferably parallel to the latter.

The cutting edge 18 can be formed at the outer end of the pivoting jaw 7, and inwardly, i.e., in the direction to the pivot axis y, captured from behind by a recess 19 that has a pocketlike longitudinal section according to FIG. 5 and opens in the direction toward the cutting mouth M.

This type of pocket-like recess 19 can also have the pivoting jaw 8 having the stop 11. The recesses 19 of both pivoting jaws 7 and 8 face each other with their openings, and can essentially thereby border the cutting mouth M.

The stop 11 can essentially be formed by a stop surface 20, which can be preferably centrally exposed to the cutting edge 18 in a closed position of the pivoting jaws, further in a longitudinal sectional view according to FIG. 8. At the very least, the cutting edge 18 is directed toward the stop surface 20 in the closed position of the pivoting jaws.

The blade 10 or its cutting edge 18 correspondingly moves around the pivot axis y along a geometric circular line L, wherein this circular line L penetrates the stop surface 20 beyond a possible stop position (see FIG. 10).

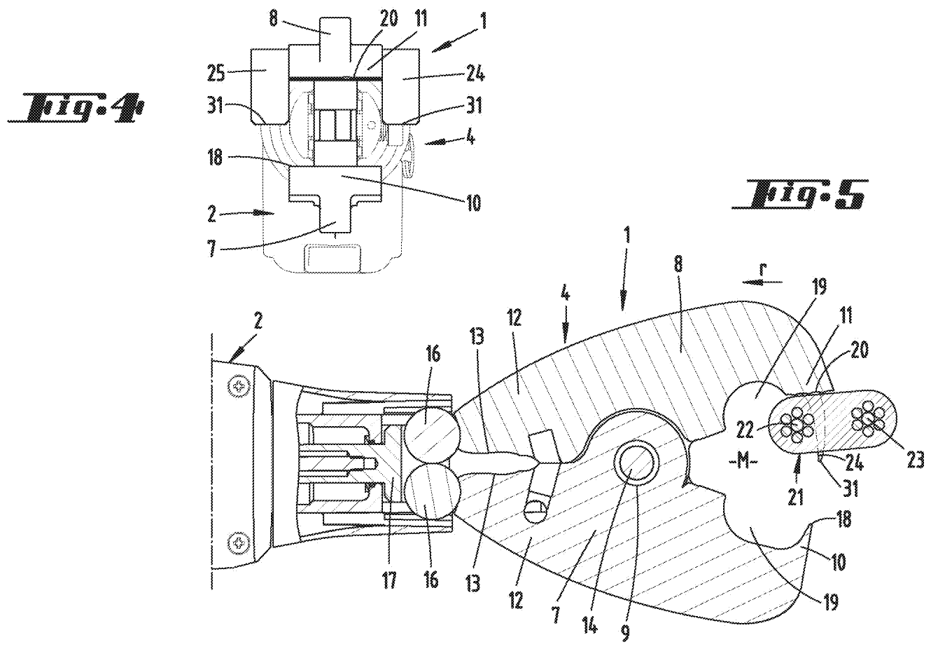

The stop surface 20 or the stop 11 and the blade 10 or its cutting edge 18 can have at least approximately the same extension lengths as viewed in the direction of the pivot axis y (see FIG. 4).

As is also preferred, this cutting edge length or stop length can correspond to a corresponding degree of extension of an H-tap 21 to be separated using the cutting tool 1.

Such an H-tap 21 is used for crimping together in particular two cables 22 and 23. Such a crimped connection can preferably only be undone by destroying the H-tap 21. The cutting tool 1 is preferably used for this purpose.

The width of an H-tap 21 in the direction of extension of the cables 22 and 23 running essentially parallel to each other can correspond to the prescribed degree of extension of the cutting edge 18 or the stop 11.

With respect to a front view according to FIG. 4, a gripping section 24 can be arranged to the side of the stop 11. In the exemplary embodiment shown, gripping sections 24 and 25 are provided on either side of the stop, and each have peripheral edges 31 on their free ends.

The gripping section 24, 25 can be pivotably mounted to the pivoting jaw 8 to the side of the stop 11. As is also preferred, the respective pivot axis z can run aligned with the pivot axis y, wherein the pivot axis z of the one gripping section 24 can further concurrently form the geometric pivot axis of the additional gripping section 25 in an axial elongation.

Each gripping section 24 and 25 preferably has two pivoting positions that can be fixedly latched. These two pivoting positions can be offset relative to each other by 180 degrees in relation to the pivot axis z.

To this end, each gripping section 24, 25, as schematically denoted on FIG. 12, can have a latching pin 26, which can be introduced into a corresponding latching recess 27 or 28 so as to fixedly latch the gripping section 24, 25.

For unlatching purposes, the gripping section 24 or 25 can be displaced along its pivot axis z against the restoring force of a spring 29 along the retaining pin 30 that forms the axial body, and then can be pivoted into the other pivoting position if needed, after which the latched position can be secured in this position by introducing the latching pin 26 into the other latching recess.

One of the gripping sections 24, 25 or even both gripping sections 24, 25 can thus be moved into a pivoting position, in which the latching pin 26 rests in the latching recess 28, and the respective gripping section protrudes over the stop surface 20 of the stop 11 with its peripheral edge 31 in the direction toward the opposing pivoting jaw 7 or the opposing blade 10. The gripping section 24 or 25 protrudes over the stop surface 20 like a fang, wherein, in an open position of the pivoting jaw as shown on FIG. 5 with reference to a projection in a plane transverse to the longitudinal axis y, the free end with the peripheral edge 31 of each gripping section 24, 25 can be spaced a distance apart from the facing cutting edge 18 viewed in the pivoting direction. This distance can correspond to a thickness of the latter viewed perpendicular to the widthwise extension of the H-tap 21, or exceed this thickness.

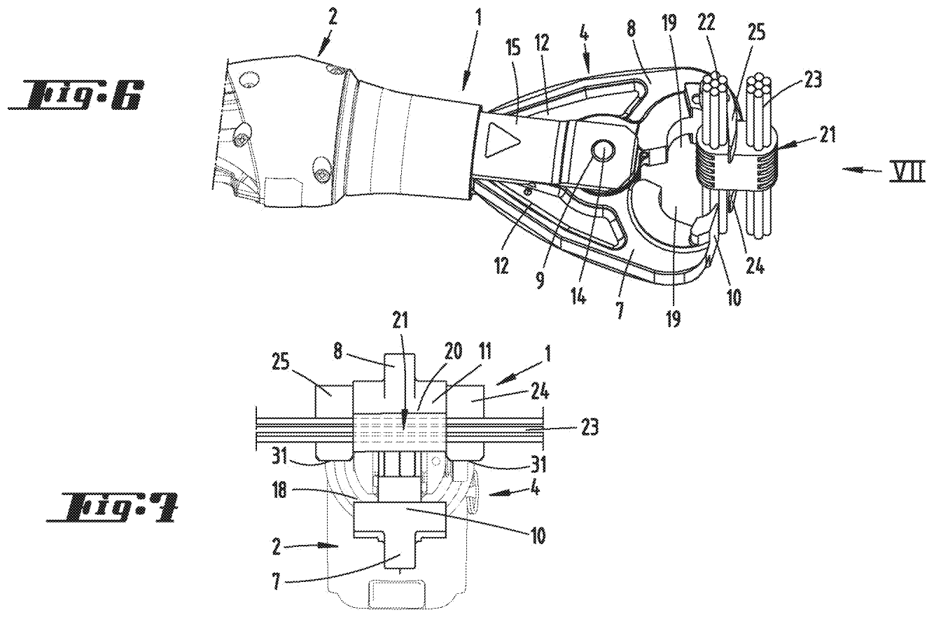

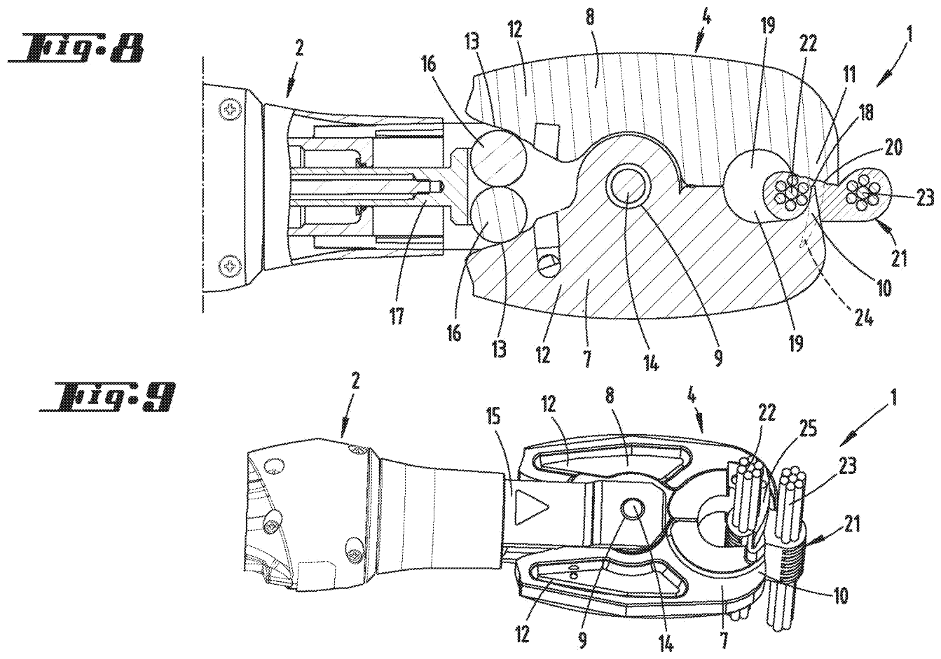

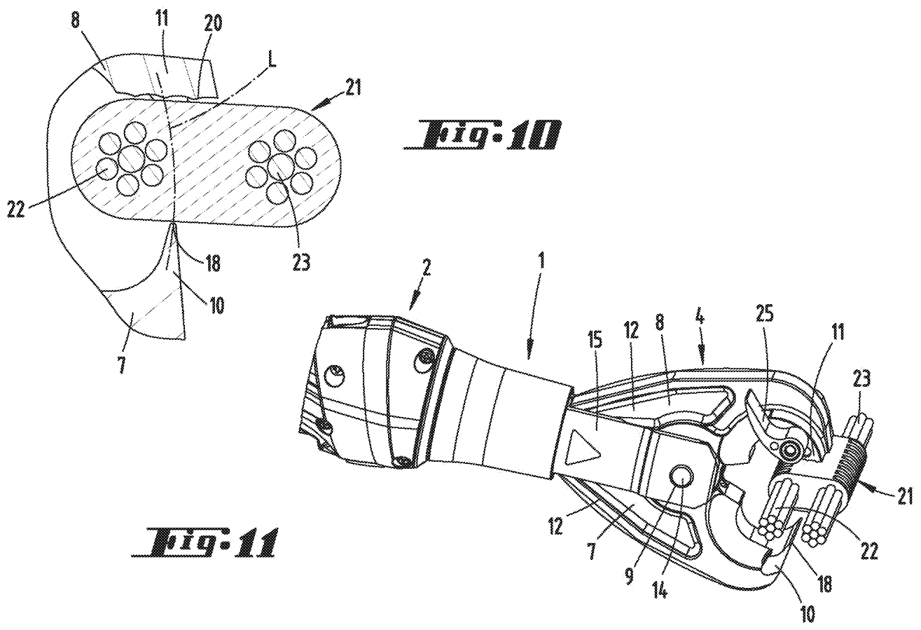

In process of cutting open an H-tap 21, both gripping sections 24 and 25 fixedly latched in the overlap position overlap the protruding cable sections of the cable 22 to be removed from the H-tap 21 to the side of the H-tap 21 (see FIG. 6). As a result, the H-tap 21 is initially guided on either side. In addition, pulling by means of the cutting tool 1 in a pulling direction r roughly along the longitudinal axis x, causes the H-tap with the overlapped cable 22 to be drawn into the interstice that arises between the gripping sections 24 and 25 and the stop surface 20, so that this results in a defined stop position of the H-tap 21.

The cable 22 to be removed from the H-tap 21 correspondingly extends inside of the cutting mouth M.

As evident from the schematic view on FIG. 10, the H-tap 21 that was brought into the correct cutting position in particular by pulling is penetrated essentially along the circular line L by the cutting edge 18 of the blade 10, thereby exposing in particular the cable 22 to be removed, wherein an approximate tangential section that at least partially arises can come about with reference to the cable cross section according to FIG. 10. The cutting edge 18 is preferably guided by the outer cable surface along the circular line L, if necessary while peeling the tap material from the cable 22. A separation of the H-tap 21 is essentially achieved in the area between the cables 22 and 23.

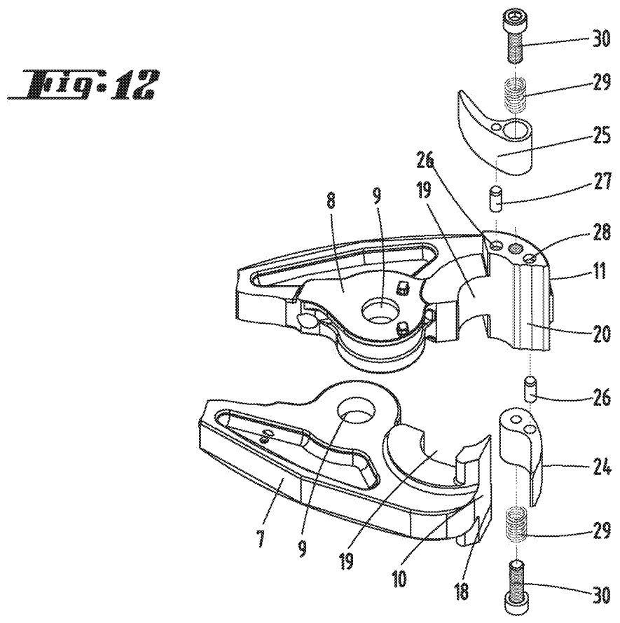

As evident from the view on FIG. 11, a gripping section 24 or 25 can be pivoted back out of the overlap position and there be fixedly latched. For example, this can happen in H-taps 21 whose width as viewed in the direction of extension of the cutting edge 18 is greater than the cutting edge length or the length of the stop surface 20, which can essentially correspond to the inner clearance of the gripping sections 24 and 25 in the direction of extension of the pivot axis z.

In such an arrangement, the gripping section 24 or 25 might thus only overlap the cable 22 on one side, and this single gripping section might produce the tensile load on the H-tap 21 for bringing the latter into the proper cutting position.

The above statements serve to describe the inventions encompassed by the application as a whole, which even independently further develop the prior art at least with the following material combinations, wherein two, several or all of these feature combinations can also be combined, specifically:

A hydraulically activated cutting tool 1, characterized in that the blade 10 has a cutting edge 18 that runs in the direction of the pivot axis y, and that a gripping section 24, 25 is provided that is formed on the pivoting jaw 8 having the stop 11 and protrudes over a stop surface 20 of the stop 11 in the direction toward the opposing pivoting jaw 7.

A cutting tool, characterized in that the gripping section 24, 25 forms a front peripheral edge 31 in the pivoting direction, which, as viewed in the direction of the pivot axis y, is arranged to the side of the cutting edge 18.

A cutting tool, characterized in that two gripping sections 24, 25 are formed, which are each arranged at one end of the stop surface 20 as viewed in the direction of the pivot axis y.

A cutting tool, characterized in that one or both gripping sections 24, 25 are pivotably arranged.

A cutting tool, characterized in that one or both gripping sections 24, 25 can be fixedly latched in at least one pivoting position.

A method for separating an H-tap crimped connection of two cables 22, 23 with a cutting tool (1) according to one of claims 1 to 5, wherein the gripping section 24, 25 is designed to overlap a cable section that extends in the longitudinal direction of the cable 22 before and/or after the H-tap 21, and that, given a gripping section 24, 25 abutting against the cable section, the blade 10 cuts through the H-tap 21 in such a way that the cable 22 can be removed.

A cutting tool or a method, characterized by one or several of the characterizing features of one of the preceding claims.

All disclosed features (whether taken separately or in combination with each other) are essential to the invention. The disclosure of the application hereby also incorporates the disclosure content of the accompanying/attached priority documents (copy of prior application) in its entirety, also for the purpose of including features of these documents in the claims of the present application. Even without the features of a referenced claim, the subclaims with their features describe independent inventive further developments of prior art, in particular for generating partial applications based on these claims. The invention indicated in each claim can additionally have one or several of the features in the above specification, in particular those provided with reference numbers and/or indicated in the reference list. The invention also relates to embodiments in which individual features mentioned in the above specification have not been realized, in particular to the extent that they are obviously unnecessary for the respective intended use, or can be replaced by other technically equivalent means.

Reference List

| | |
|---|---|
| 1 | Cutting tool |
| 2 | Drive unit part |
| 3 | Gripping area |
| 4 | Working head |
| 5 | Accumulator |
| 6 | Activating key |
| 7 | Pivoting jaw |
| 8 | Pivoting jaw |
| 9 | Bearing eye |
| 10 | Blade |
| 11 | Stop |
| 12 | Jaw leg |
| 13 | Acting surface |
| 14 | Bolt |
| 15 | Receiving neck |
| 16 | Roller |
| 17 | Piston rod |
| 18 | Cutting edge |
| 19 | Recess |
| 20 | Stop surface |
| 21 | H-tap |
| 22 | Cable |
| 23 | Cable |
| 24 | Gripping section |
| 25 | Gripping section |
| 26 | Latching pin |
| 27 | Latching recess |
| 28 | Latching recess |
| 29 | Spring |
| 30 | Retaining pin |
| 31 | Peripheral edge |
| r | Pulling direction |
| x | Longitudinal axis |
| y | Pivot axis |
| z | Pivot axis |
| L | Circular line |
| M | Cutting mouth |

1. A hydraulically activated cutting tool comprising:
first and second pivoting jaws pivotable around a shared pivot axis which extends in a direction, the jaws being pivotable around the pivot axis in a pivoting direction;
a blade formed on the first pivoting jaw, the blade having a cutting edge that extends in the direction of the pivot axis;
a stop is formed on the second pivoting jaw, the stop having a stop surface;
a gripping section formed on the second pivoting jaw and which protrudes over the stop surface a direction toward the first pivoting jaw.

2. The cutting tool according to claim 1, wherein the gripping section forms a front peripheral edge (31) in the pivoting direction, which, as viewed in the direction of the pivot axis, is arranged to a side of the cutting edge.

3. The cutting tool according to claim 1, wherein two gripping sections are formed, which are each arranged at one end of the stop surface as viewed in the direction of the pivot axis.

4. The cutting tool according to claim 3, wherein one or both gripping sections are pivotably arranged.

5. The cutting tool according to claim 3, wherein one or both gripping sections can be fixedly latched into at least one pivoting position.

6. A method configured to separate a crimped connection, which connects two strand-shaped cables in the form of an H-tap crimped connection, with a cutting tool comprising:
providing a hydraulically activated cutting tool including first and second pivoting jaws pivotable around a shared pivot axis which extends in a direction, the jaws being pivotable around the pivot axis in a pivoting direction, a blade formed on the first pivoting jaw, the blade having a cutting edge that extends in the direction of the pivot axis, a stop is formed on the second pivoting jaw, the stop having a stop surface, a gripping section formed on the second pivoting jaw and which protrudes over the stop surface a direction toward the first pivoting jaw;
overlapping the gripping section over sections of the strand-shaped cables that extend in the a longitudinal direction of the strand-shaped cables before and/or after the crimped connection, wherein the gripping section abuts against one of the strand-shaped cable;
cutting through the crimped connection with the blade such that one of the strand-shaped part cables can be removed.

7. (canceled)

8. The cutting tool according to claim 2, wherein two gripping sections are formed, which are each arranged at one end of the stop surface as viewed in the direction of the pivot axis.

9. The cutting tool according to claim 8, wherein one or both gripping sections are pivotably arranged.

10. The cutting tool according to claim 8, wherein one or both gripping sections can be fixedly latched into at least one pivoting position.

11. The cutting tool according to claim 1, wherein the gripping section is pivotably arranged.

12. The cutting tool according to claim 1, wherein the gripping section can be fixedly latched into at least one pivoting position.

13. The cutting tool according to claim 2, wherein the gripping section is pivotably arranged.

14. The cutting tool according to claim 2, wherein the gripping section can be fixedly latched into at least one pivoting position.

15. The cutting tool according to claim 4, wherein both gripping sections can be fixedly latched into at least one pivoting position.
